(19) United States
(12) Patent Application Publication
(10) Pub. No.: US 2021/0213802 A1
(43) Pub. Date: Jul. 15, 2021

(54) VENTILATION SYSTEM PROVIDED WITH A REFRIGERATED CONTAINER

(71) Applicant: Carrier Corporation, Palm Beach Gardens, FL (US)

(72) Inventors: Ciara Nichole Poolman, Syracuse, NY (US); Kurt Handley, Jordan, NY (US); Lei Chen, South Windsor, CT (US)

(21) Appl. No.: 15/733,980

(22) PCT Filed: Jul. 30, 2019
(86) PCT No.: PCT/US2019/044070

§ 371 Date: Dec. 1, 2020

Related U.S. Application Data
(60) Provisional application No. 62/711,782, filed on Jul. 30, 2018.

(51) Int. Cl. B60H 1/00; B60H 1/32; F25B 49/00

(52) U.S. Cl. CPC B60H 1/00978; B60H 1/00864; F25B 2500/222; F25B 49/005; B60H 1/3232

(57) ABSTRACT

A refrigerated container (10) that includes a container (10), an auxiliary lock (42), and a ventilation system. The container (10) defines an interior space (14) and has a door (30) to selectively permit access to the interior space (14). The auxiliary lock (42) is arranged to selectively inhibit the door (30) from moving from the closed position towards the open position. The ventilation system includes a leak sensor (44) and a controller (48). The leak sensor (44) is arranged to provide a signal indicative of a concentration of a refrigerant within the interior space (14) of the container (10). The controller (48) is arranged to receive the signal and is programmed to command the auxiliary lock (42) to move towards the lock position, responsive to the signal being indicative of the concentration of the refrigerant within the interior space (14) being greater than a threshold.

### BACKGROUND

Products such as produce or meat may be shipped relatively long distances and may be placed within refrigerated containers. These refrigerated containers are specifically designed for conditioning an interior space with refrigerated air for an extended period of time. These refrigerated containers utilize a refrigeration unit that circulates cooled air inside the interior space through evaporator fans, which direct the air from the front of the container to the rear. Refrigerant from the refrigeration unit may leak inside the refrigerated container.

### SUMMARY

Disclosed is a refrigerated container that includes a container, an auxiliary lock, and a ventilation system. The container defines an interior space and has a door movable between a closed position and an open position to selectively permit access to the interior space. The auxiliary lock is arranged to move between an unlock position and a lock position that inhibits the door from moving from the closed position towards the open position. The ventilation system includes a leak sensor and a controller. The leak sensor is arranged to provide a signal indicative of a concentration of a refrigerant within the interior space of the container. The controller is arranged to receive the signal and is programmed to command the auxiliary lock to move towards the lock position, responsive to the signal being indicative of the concentration of the refrigerant within the interior space being greater than a threshold.

Also disclosed is a refrigerated container that includes a container defining an interior space, a refrigeration system, and a ventilation system. The refrigeration system has a fan rotatable in a first direction in which a cooled fluid is distributed about the interior space and a second direction to facilitate ventilation of the interior space. The ventilation system includes a leak sensor and a controller. The leak sensor is arranged to provide a signal indicative of a concentration of a refrigerant within the interior space of the container. The controller is arranged to receive the signal.

These and other advantages and features will become more apparent from the following description taken in conjunction with the drawings.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a side view of a vehicle having a refrigerated container;

FIGS. 2A and 2B are views of the refrigerated container having a vent door in a closed position;

FIGS. 3A and 3B are views of the refrigerated container having the vent door in an open position;

FIGS. 4A and 4B are views of the refrigerated container having the vent door in an open position and a ventilation fan turned on; and

FIGS. 5A and 5B are views of the refrigerated container having a vent door in a closed position; and

FIGS. 6A and 6B are views of the refrigerated container having the vent door in an open position.

### DETAILED DESCRIPTION

Referring to the Figures, a refrigerated trailer or a refrigerated container 10 may be provided with a refrigeration system 12 that provides conditioned air or cooled air to an interior space 14 of the refrigerated container 10. The refrigeration system 12 may be adapted to operate using a refrigerant such as a low global warming potential refrigerant including A1, A2, A2L, A3, etc. The refrigerant may leak into the interior space 14 of the refrigerated container 10. The refrigerant may present a hazard should the concentration of the leaked refrigerant within the confined space exceed a threshold level. The threshold level may be a lower flammability limit of the refrigerant.

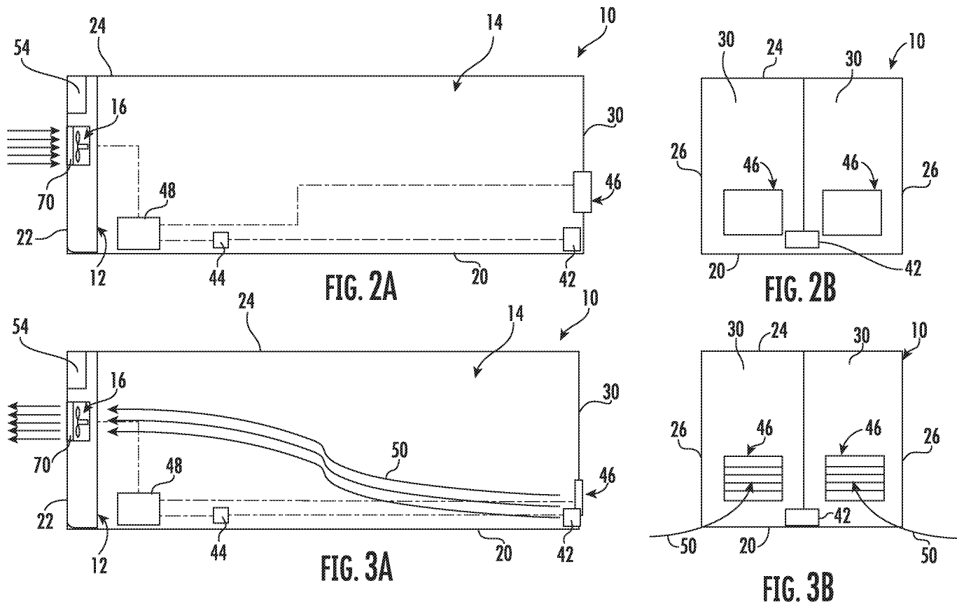

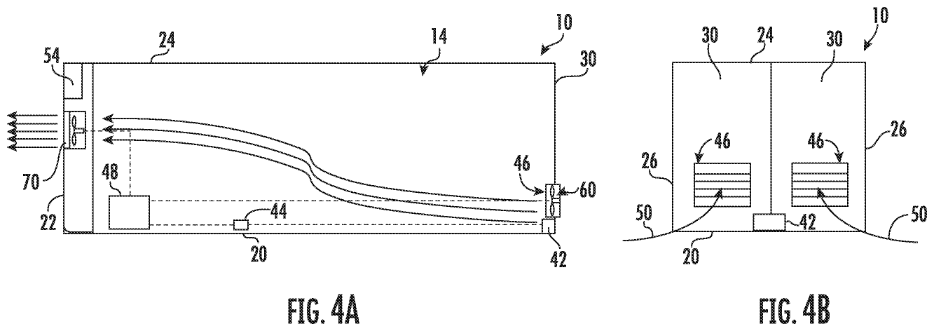

The refrigeration system 12 includes a fan 16 that may be a push/or pull fan. The fan 16 may be a condenser fan, an evaporator fan, a distribution fan, or the like. The fan 16 may be rotatable in a first direction in which a cooled fluid such as the conditioned air, is distributed about the interior space 14 of the refrigerated container 10, as shown in FIG. 2A. The fan 16 may be rotatable in a second direction, which is disposed opposite the first direction that facilitates ventilation of the interior space 14 of the refrigerated container 10, as shown in FIGS. 3A and 4A. The fan 16 may be rotatable in a first direction in which cooling air flow is distributed about the interior space 14 of the refrigerated container 10. The fan 16 may be rotatable in a second direction, which is disposed opposite the first direction, that facilitates the ventilation of the interior space 14 of the refrigerated container 10 and directed outside of the interior space 14, as shown in FIG. 5A.

Referring to the Figures, the interior space 14 of the refrigerated container 10 may be defined by a floor 20, a front wall 22, a top wall 24, and a pair of side walls 26. The floor 20 extends between proximal ends of the front wall 22 and the pair of side walls 26. The floor 20 is spaced apart from and is disposed opposite the top wall 24. The front wall 22 extends between first ends of the floor 20 and the top wall 24. The top wall 24 extends between distal ends of the front wall 22 and the pair of side walls 26. The top wall 24 is disposed opposite the floor 20. The pair of side walls 26 extend between the floor 20 and the top wall 24.

Referring to FIGS. 2A-6B, the refrigerated container 10 includes a door 30 that may be disposed opposite the front wall 32, such that the door 30 is integrated with a rear wall or is at least partially defined by a rear wall. In at least one embodiment, the door 30 may be defined in other walls of the refrigerated container 10 such as a sidewall of the pair of side walls 26. The door 30 is movable between a closed position and an open position to selectively permit access to the interior space 14 of the refrigerated container 10.

A ventilation system may be provided to mitigate leakage of the refrigerant into the interior space 14 by venting the leaked refrigerant to an external environment through use of the fan 16 of the refrigeration system 12. The ventilation system is arranged to mitigate leakage of the refrigerant from the refrigeration system 12 from within the interior space 14 by providing fresh air intake and/or refrigerant/air mixture removal from the interior space 14.

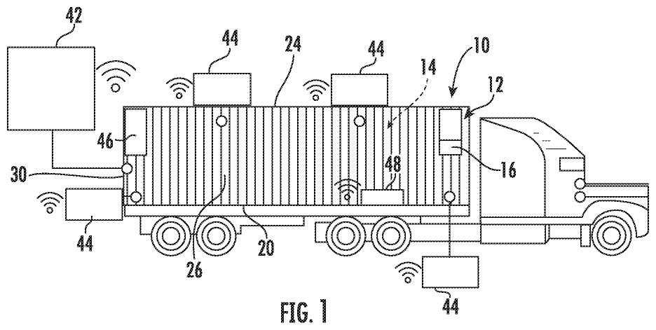

Referring to FIGS. 1-6B, the ventilation system includes an auxiliary lock 42, a leak sensor 44, a vent door 46, and a controller 48.

The auxiliary lock 42 may be provided as part of the ventilation system or may be a separately provided component that is in communication with the ventilation system. The auxiliary lock 42 may be a wireless lock that is installed on the refrigerated container 10. The auxiliary lock 42 is arranged to selectively inhibit the opening of the door 30. The auxiliary lock 42 is arranged to be movable between an unlock position that permits the door 30 to move from the closed position towards the open position and a lock position that inhibits the door 30 from moving from the closed position towards the open position.

The auxiliary lock 42 functions as an interlock mechanism to inhibit human exposure to the refrigerant by inhibiting access to the interior space 14. The interlock mechanism may also help maintain a temperature within the interior space 14 for the prolonged preservation of the goods that may be transported.

The leak sensor 44 is arranged to provide a signal indicative of a concentration of a refrigerant that may be present within the interior space 14. The leak sensor 44 is disposed within the interior space 14, proximate the refrigeration system 12 or proximate the floor 20. The leak sensor 44 is in communication with at least one of the auxiliary lock 42, the vent door 46, and/or the controller 48. The leak sensor 44 may be in wired or wireless communication with at least one of the auxiliary lock 42, the vent door 46, and/or the controller 48.

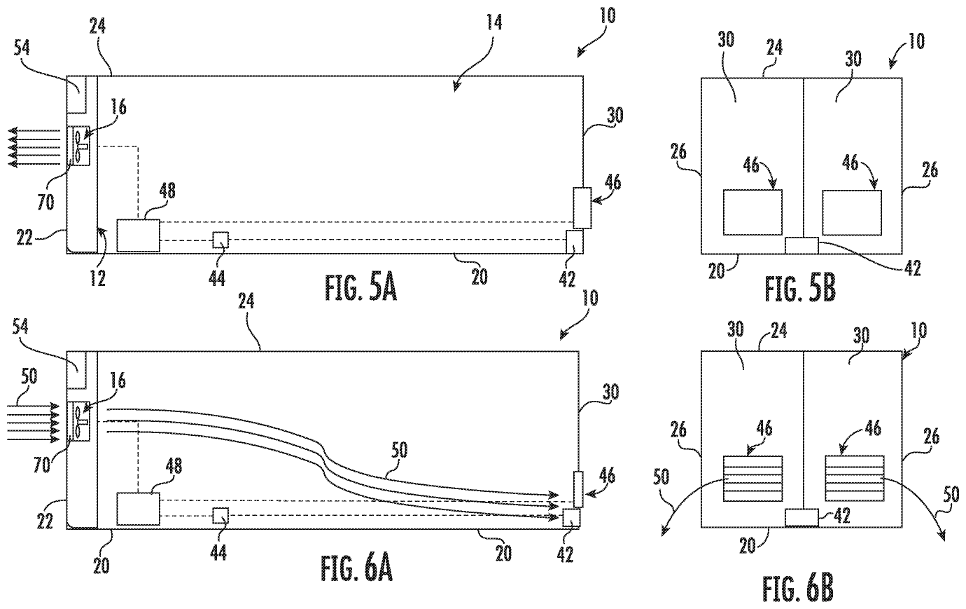

The vent door 46 is disposed on the refrigerated container 10 and is movable between a closed position, as shown in FIGS. 2B and 5B, and an open position, as shown in FIGS. 3A, 3B, 4A, 4B, to selectively facilitate the entrance or inflow of ambient air 50 into the interior space 14, and an open position in which airflow is vented through the vent door 46, as shown in FIGS. 6A and 6B. The vent door 46 may be disposed on a wall of the refrigerated container 10 or may be at least one of disposed on or extend through the door 30, as shown in FIGS. 2A-46B. The vent door 46 may be disposed on other walls, the floor 20, or the top wall 24 of the refrigerated container 10.

The vent door 46 may be a vent such as an exhaust vent, a flapper vent, a motor driven vent door, a movable grate, or the like. In at least one embodiment, the vent door 46 may be disposed on the door 30 and a second vent door 54 may be disposed on the front wall 22 or the top wall 24. Responsive to the detection of a refrigerant within the interior space 14 being greater than a threshold, the vent door 46 and the second vent door 54 may be opened to induce a fluid flow through the interior space 14, without operating the fan 16.

The vent door 46 is in communication with at least one of the auxiliary lock 42, the leak sensor 44, and/or the controller 48. The vent door 46 may be in wired or wireless communication with at least one of the auxiliary lock 42, the leak sensor 44, and/or the controller 48.

In at least one embodiment, a ventilation fan 60 may be placed within the vent door 46. The ventilation fan 60 is arranged to facilitate the drawing or inflow of ambient air 50 into the interior space 14, as shown in FIGS. 4A and 4B, while the vent door 46 is in an open position.

The controller 48 may be provided with the refrigeration system 12 or may be a standalone controller that is in communication with the refrigeration system 12. The controller 48 is in communication with auxiliary lock 42, the leak sensor 44, the vent door 46, and in some embodiments the ventilation fan 60.

The controller 48 is provided with input communication channels that are arranged to receive the signal indicative of the concentration of the refrigerant within the interior space 14 from the leak sensor 44. The controller 48 is provided with output communication channels that are arranged to provide signals or commands to the fan 16, the auxiliary lock 42, and/or the vent door 46, and in some embodiments, an actuator that is arranged to facilitate the movement of the vent door 46 between the closed position and the open position.

The controller 48 is provided with at least one processor that is programmed to perform control logic, control algorithms, or functions to command the following: 1) the auxiliary lock 42 to move between the unlock position and the lock position; 2) change the direction of rotation of the fan 16 to direct fluid outside of the interior space 14; 3) facilitate the movement of the vent door 46 between the closed position and the open position, based on the signal indicative of the concentration levels of refrigerant within the interior space 14 of the refrigerated container 10.

Responsive to the signal being indicative of the concentration of the refrigerant within the interior space 14 being greater than a threshold, the controller 48 is programmed to: 1) output for display, a warning or an indicator indicative of the presence of refrigerant within the interior space 14; 2) command the auxiliary lock 42 to move towards the lock position; 3) command at least one of the vent door 46 and the second vent door 54 to move towards the open position; and/or 4) command at least one of the fan 16 to rotate in the second direction and/or command the ventilation fan 60 to operate. The opening of at least one of the vent door 46 and the second vent door 54 as well as the operation of at least one of the fan 16 and/or the ventilation fan 60 enables the removal of refrigerant from the interior space 14 through either an air outlet 70 that is defined proximate the front wall 22 of the refrigerant the container 10, as shown in FIGS. 3A and 4A, or through the vent door 46, as shown in FIG. 6B.

Responsive to the signal being indicative of the concentration of the refrigerant within the interior space 14 being less than the threshold, the controller 48 is programmed to: 1) command the vent door 46 to move towards the closed position; 2) inhibit at least one of the fan 16 and the ventilation fan 60 from rotating; and/or 3) command the auxiliary lock 42 to move towards the unlock position.

The ventilation system enables the removal of refrigerant from within the interior space 14 through fresh air intake via the vent door 46 and exhaust through the air outlet 70. The ventilation fan 60 provides additional airflow to facilitate the fresh air exchange or ventilation of the refrigerant. The arrangement of the ventilation system is particularly applicable to multi temperature refrigerated containers having dividing walls that inhibit the free flow of air about the entire refrigerated container.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description.

What is claimed is:

1. A refrigerated container, comprising:
a container defining an interior space and having a door movable between a closed position and an open position to selectively permit access to the interior space;
an auxiliary lock arranged to move between an unlock position and a lock position that inhibits the door from moving from the closed position towards the open position; and
a ventilation system, comprising:
a leak sensor arranged to provide a signal indicative of a concentration of a refrigerant within the interior space of the container; and
a controller arranged to receive the signal, the controller being programmed to command the auxiliary lock to move towards the lock position, responsive to the signal being indicative of the concentration of the refrigerant within the interior space being greater than a threshold.

2. The refrigerated container of claim 1, wherein the controller is further programmed to command the auxiliary lock to move towards the unlock position, responsive to the signal being indicative of the concentration of the refrigerant within the interior space being less than a threshold.

3. The refrigerated container of claim 1, wherein the controller is further programmed to output for display an indicator.

4. The refrigerated container of claim 1, further comprising:
a refrigeration system having a fan rotatable in a first direction in which a cooled fluid is distributed about the interior space and a second direction in which a fluid is directed outside of the interior space.

5. The refrigerated container of claim 4, wherein the leak sensor is disposed within the interior space and disposed proximate the refrigeration system.

6. The refrigerated container of claim 4, wherein the ventilation system further comprising a vent door that is at least one of disposed on and extends through the door and is movable between an open position and a closed position.

7. The refrigerated container of claim 6, wherein the controller is further programmed to command the vent door to move towards the open position, responsive to the signal being indicative of the concentration of the refrigerant within the interior space being greater than the threshold.

8. The refrigerated container of claim 6, wherein the controller is further programmed to command the fan to rotate in the second direction, responsive to the signal being indicative of the concentration of the refrigerant within the interior space being greater than the threshold.

9. A refrigerated container, comprising:
a container defining an interior space;
a refrigeration system having a fan rotatable in a first direction in which a cooled fluid is distributed about the interior space and a second direction to facilitate ventilation of the interior space; and
a ventilation system, comprising:
a leak sensor arranged to provide a signal indicative of a concentration of a refrigerant within the interior space of the container; and
a controller arranged to receive the signal.

10. The refrigerated container of claim 9, wherein the ventilation system further comprising a vent door disposed on the container and movable between an open position and a closed position.

11. The refrigerated container of claim 10, wherein the controller is programmed to command the vent door to move towards the open position, responsive to the signal being indicative of the concentration of the refrigerant within the interior space being greater than a threshold.

12. The refrigerated container of claim 11, wherein the controller is further programmed to command the fan to rotate in the second direction, responsive to the signal being indicative of the concentration of the refrigerant within the interior space being greater than a threshold.

13. The refrigerated container of claim 12, wherein the controller is further programmed to command the vent door to move towards the closed position, responsive to the signal being indicative of the concentration of the refrigerant within the interior space being less than the threshold.

14. The refrigerated container of claim 12, wherein the controller is programmed to inhibit the fan from rotating, responsive to the signal being indicative of the concentration of the refrigerant within the interior space being less than the threshold.

15. The refrigerated container of claim 10, wherein the ventilation system further comprising:
a ventilation fan disposed within the vent door arranged to draw air from outside the container into the interior space.

16. The refrigerated container of claim 15, wherein the controller is further programmed to:
command the vent door to move towards the open position,
command the fan to rotate in the second direction, and
command the ventilation fan to operate,
responsive to the signal being indicative of the concentration of the refrigerant within the interior space being greater than a threshold.

17. The refrigerated container of claim 10, wherein the container has a door movable between a closed position and an open position to selectively permit access to the interior space.

18. The refrigerated container of claim 17, wherein the vent door is at least one of disposed on and extends through the door.

19. The refrigerated container of claim 17, further comprising:
an auxiliary lock arranged to move between an unlock position that permits the door to move from the closed position towards the open position and a lock position that inhibits the door from moving from the closed position towards the open position.

20. The refrigerated container of claim 19, wherein the controller is further programmed to command the auxiliary lock to move towards the lock position, responsive to the signal being indicative of the concentration of the refrigerant within the interior space being greater than a threshold.
